(19) United States
(12) Patent Application Publication
(10) Pub. No.: US 2014/0180824 A1
(43) Pub. Date: Jun. 26, 2014

(54) Usage of video for advertising and marketing on a web or mobile platform

(71) Applicant: Shahzeen Rehman, Scottdale, GA (US)

(72) Inventor: Shahzeen Rehman, Scottdale, GA (US)

(21) Appl. No.: 14/140,651

(22) Filed: Jan. 27, 2014

(51) Int. Cl. G06Q 30/02

(52) U.S. Cl. CPC G06Q 30/0267; G06Q 30/0277
USPC 705/14.64

(57) ABSTRACT

The websites that features deals and coupons from retail businesses and other directory or classified websites only features descriptions and photos of businesses that advertise on these websites and mobile applications.

We want to patent the idea of using videos as a form of advertisement on any of such kinds of websites or mobile applications.

Example a clothing store is featuring a coupon on couponing or deal website, a video is added which provides more insight about that businesses to the consumer. A video presentation is more engaging and proves beneficial to the business.

Patent the idea of using videos as a form of advertisement for a retail business And using these videos as a form of advertisement on a classified, business listing , advertising, deals, couponing and reviews website or a mobile application.

Currently there are no classified, listing, couponing, deals or reviews website or mobile application that uses videos as a form of advertisement.

The video advertisement will provide better exposure to a business amongst its new and existing customers.

1. Protect and patent the idea of using videos as a form of advertisement for a retail business on these platforms:
Website or mobile application that features classified and business listing
Website or mobile application that features coupons and deals of retail businesses
Website or mobile application that features reviews of retail businesses
